(19) United States
(12) Patent Application Publication
(10) Pub. No.: US 2005/0108418 A1
(43) Pub. Date: May 19, 2005

(54) Method and system for updating/reloading the content of pages browsed over a network

(75) Inventors: Bharat V. Bedi, Southsea (GB); Andrew J. Stanford-Clark, Chale (GB)

Correspondence Address: IBM Corporation;IP Law Department, 11400 Burnet Road, Austin, TX, 78758, US

(73) Assignee: INTERNATIONAL BUSINESS MACHINES CORPORATION, ARMONK, NY (US)

(21) Appl. No.: 10/814,735

(22) Filed: Mar. 31, 2004

(30) Foreign Application Priority Data
Nov. 19, 2003 (GB) 0326915.6

(51) Int. Cl. G06F 15/16

(52) U.S. Cl. 709/232

(57) ABSTRACT

The present invention provides a real-time means of automatically updating the content of a user pre-selected set of web pages without any activity required on the part of the user to initiate each web page updating procedure. This is achieved by incorporating into a browser of a user's computing device software code that is responsive to real-time web page content change notification messages to cause the browser to reload a URL identified in the change notification message. Alternatively, the software code may comprise a Java applet or the like embedded in a downloaded web page that is responsive to change notification messages to cause the browser to reload a web page whose URL is identified in the message or to reload a currently displayed web page. The change notification messages are generated by applications whose web page content has changed and the messages are relayed in real-time to push client agents comprising said software code by a message broker agent. The invention offers many advantages including reducing unnecessary web page reload operations and thus reducing network traffic.

### FIELD OF THE INVENTION

The present invention relates to a method and system for updating/reloading the content of pages browsed over a network and particularly, but not exclusively, to updating/reloading the content of pages browsed over the Internet.

### BACKGROUND TO THE INVENTION

A browser is a software program that is run on a client computing device such as a personal computer (PC), for example, that enables the client computing device to retrieve a page from a server over a network. The page contains data comprising a content of a document, its structure, layout and physical format and links to other documents and media objects in the system. The browser interprets the retrieved page and displays the contents of the document on a monitor of the client computing device. Typically, the network comprises a plurality of client computing devices and a plurality of servers hosting a vast number of pages that can be accessed by a user through their client computing device. Each page has a unique network address which is utilised by a browser as the means of locating the page in the system and obtaining a copy of it from the server hosting it.

The Internet is the most universally recognised example of such a network linking an almost unlimited number of servers and client computing devices throughout the world. The World Wide Web (WWW) is the universal term used to refer to the Internet and the massive collection of web pages that are accessible through it.

In the case of the Internet, a web browser is the primary software program run on a client computing device for connecting it to a server, retrieving a web page from the server, interpreting the web page and then displaying its contents on the client computing device's monitor. In contrast, server software for handling the storage and transmission of web pages runs exclusively on the server devices. What binds the servers and client computing devices together is their ability to communicate with each other over the Internet using various protocols and, in particular, the Hypertext Transfer Protocol (HTTP) which can be considered for the present at least as the primary protocol for Internet communication.

WWW document files (web pages) transmitted between servers and client computing devices are written in a text-formatting language called Hypertext Markup Language (HTML) that describes the structure and character formatting of the document file content. A web page is simply a HTML data-set of text and instructions that is understood by the client computing device browser software. A web page can contain links to other such pages and media objects located in the Internet. Such links form part of the displayed contents of the web page.

A Uniform Resource Locator (URL) specifies the Internet address of a web page stored on disk by a server or dynamically configurable by a server connected to the Internet. Every page on the Internet, no matter what its access protocol, has a unique URL. A web browser uses the URL to retrieve the page from the server hosting it. URLs are in reality user friendly forms of the numeric, binary coded domain name Internet Protocol (IP) addresses that are actually employed in the Internet.

Web browsers offer greater functionality than just retrieving web page and displaying their content on a client computing device monitor. For example, known web browsers such as Microsoft Internet Explorer and Netscape Navigator offer additional functions such as “bookmarks” or “favourites”. These enable a user to record the addresses of websites that the user may wish to revisit. This will comprise a stored list of URLs for those websites. The user can access the list and click on the link of the website to be revisited rather than retyping the entire address or attempting to locate a link to it in another document.

Another functionality offered by known web browsers is “reload” or “refresh” whereby, when a web page is downloaded, the web page data is cached, i.e. stored temporarily in the client computing device's memory. When that page is next requested, instead of requesting the web page file from the server, the web browser accesses it from the client computing device cache (memory). But if a web page is frequently updated then the cached content may no longer be current. By choosing to reload (refresh) the web page, this timely data is updated (i.e. reloaded) from the server.

Disadvantages with the reload or refresh feature include the need for positive action on the part of the user to reload the web page, but this requires an awareness on the part of the user that the content of the web page is regularly updated and to overcome the natural inertia which predisposes the user to use stored bookmarks and/or shortcuts as the primary route to accessing a web page. Also, in many cases, the content of the web page will not have changed or changed by an insignificant amount and thus the reload operation is of no benefit to the user and is wasteful of network resources.

There have been a number of attempts to address the issue of automatically indicating to a user when the content of a bookmarked web page has been changed. One such attempt is disclosed in U.S. Pat. No. 5,813,007. This teaches the use of electronic mail (email) notifications to highlight URL bookmarks whose content has changed on the server hosting it. The user can then access the notified URL to reload the web page file. This is a form of a polling method for updating bookmarked web pages that requires an action on the part of the user.

Another such attempt is disclosed in U.S. Pat. No. 5,978,828. This teaches the use of a polling method by a client computing device browser to determine the degree by which the content of a bookmarked web page file has changed and, if the degree of change exceeds a threshold, the client computing device reloads the web page file to access the current content. Whilst this method reduces the number of unnecessary reload operations, it relies on the browser to poll URLs to determine if web page content has changed and whether the change is significant enough to trigger a reload operation. In the absence of a user manually initiating a reload of a web page to access current content, the user is at the mercy of the threshold and how that is determined as to whether a web page is reloaded to provide access to current content.

A further attempt to address this issue is known from U.S. Pat. No. 6,055,570. This teaches the provision of an update monitoring service that a user can register with to indicate their interest in learning about changes to web page content of certain URLs. The monitoring service either polls websites for changes in content or receives notification of changes. The user then connects to the monitoring service and is presented with a list of URLs of interest whose content has changed. There is no mechanism in this disclosure of automatically updating a web page file in a web browser in real-time in response to a notification that the web page content has changed.

It is an object of the present invention to mitigate or obviate disadvantages associated with the foregoing.

It is a further object of the invention to provide a method and system for causing a client computing device browser to automatically update/reload a page containing data comprising a content of a document, its structure, layout and physical format and links to other documents and media objects from a server over a network.

It is yet a further object of the invention to provide a method and system for causing a browser on a client computing device to automatically update/reload a page whose content has changed on receipt of a notification of the changed content of the page.

### SUMMARY OF THE INVENTION

In accordance with a first aspect of the invention, there is provided a method of automatically reloading a page on a client computing device, characterised in that it comprises the steps of: storing a page on a server; transmitting a copy of the page to a browser of the client computing device in response to a request from said browser received at said server, said copy of the page being transmitted to the browser over a network connecting the client computing device to the server; updating the content of the page stored on the server; simultaneously transmitting a message to said browser notifying it of a change in the content of the page; and on receipt of said change content message, causing said browser to automatically request a copy of the updated page.

Preferably, the change message is generated by an application implementable by the server and the change message is relayed to the browser of the client computing device by a message broker server.

The message broker server may comprise a publish/subscribe engine such that the change message is communicated to the browser using a socket transport protocol.

Preferably also, the method includes the steps of the client computing device browser registering with the message broker server the network address of a page and the message broker server determining on the basis of said registered network file address whether a received change message is to be communicated to the browser.

The browser may register with the message broker server a plurality of network addresses for pages which are used by the message broker server to determine if a received change message is to be communicated to the browser.

Preferably, the network addresses registered by the browser with the message broker agent/server comprise a user selected list of network addresses.

The program code for causing said browser to automatically request a copy of the updated page upon receipt of a change message may form part of the browser software.

Alternatively, the program code for causing said browser to automatically request a copy of the updated page upon receipt of a change message comprises a Java applet embedded in a downloaded page.

In accordance with a second aspect of the invention, there is provided a system for automatically reloading a page on a client computing device, characterised in that it comprises: a server for storing a page; a client computing device having a browser; a network connecting the server to the client computing device, the arrangement being such that a copy of the page stored on the server is transmitted over the network to the browser of the client computing device in response to a request received at the server from the browser; a message broker agent for receiving a message that the content of the page has been changed and for transmitting in real-time a message to the browser to notify it that said content has been changed; wherein said browser is arranged, upon receipt of the change message, to request an updated copy of the page from the server.

Preferably, the server comprises an application server for implementing applications.

Preferably also, the message broker agent comprises a publish/subscribe engine and wherein the message broker agent and a push client agent of the browser are connected by a Transport Control Protocol/Internet Protocol (TCP/IP) socket connection.

In accordance with a third aspect of the invention, there is provided a client computing device for implementing the method of the invention.

In accordance with a fourth aspect of the invention, there is provided a message broker server for implementing the method of the invention.

In accordance with a fifth aspect of the invention, there is provided a software code for implementing the method of the invention.

In accordance with a sixth aspect of the invention, there is provided a computer program on a machine readable medium for implementing a browser for a client computing device for implementing the method of the invention.

### BRIEF DESCRIPTION OF THE DRAWINGS

The foregoing and further features of the present invention will be more readily understood from descriptions of preferred embodiments, by way of example only, with reference to the drawings of which:

FIG. 1 is a block diagram in accordance with a first embodiment of the invention;

FIG. 2 is a block schematic diagram of a page including an embedded Java applet as a push client agent of a client computing device browser; and

FIG. 3 is a block diagram of a second embodiment in accordance with the invention.

### DESCRIPTION OF THE PREFERRED EMBODIMENTS

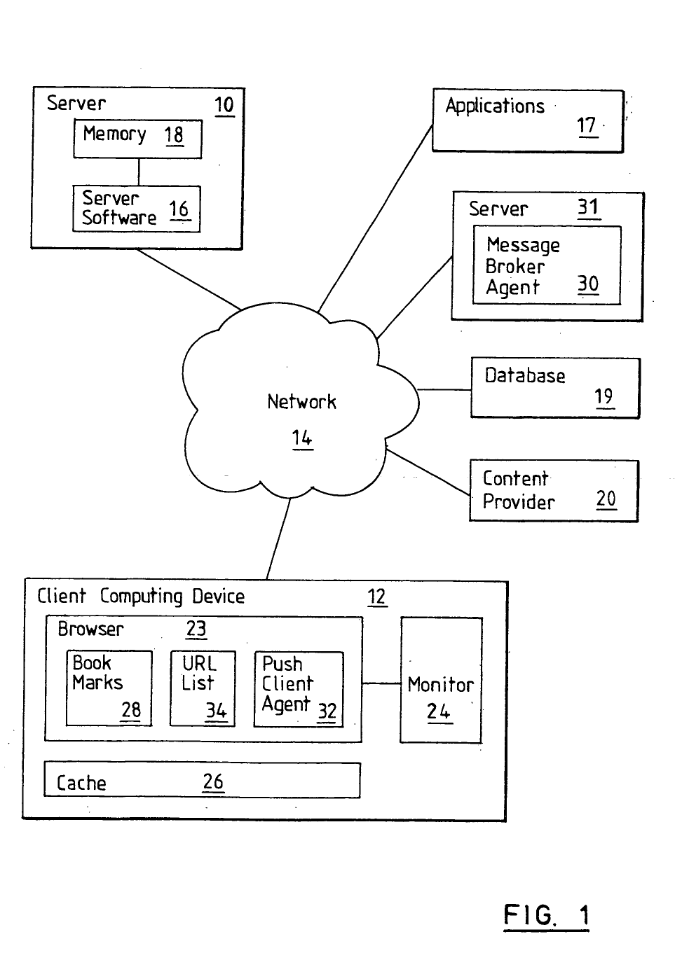

Referring to FIG. 1, there is shown a first preferred embodiment in accordance with the invention. This comprises a server 10 connected to a client computing device 12 via a network 14. The network 14 may comprise the Internet but equally could comprise a private network offering access only to authorised users. Whilst only a single server 10 and client computing device 12 are shown, it will be appreciated that the network 14 may interconnect a plurality of client computing devices to a plurality of servers.

The server 10 has server software 16 which controls the operation of the server in a known manner including the storage and transmission over the network 14 of pages stored in a memory 18 of the server 10. The server 10 may comprise a web server or the like wherein it provides access to pages stored on disk. Such pages are generally ‘static’ in nature in that the pages are accessible by all users and their content is the same for all users. However, in a preferred implementation of the invention, the server 10 comprises an application server 10 which has the capability to implement applications (denoted as 17 in FIG. 1) and, in association therewith, dynamically generate some of the content of a requested page such as a web page. Whilst the applications 17 are shown in FIG. 1 as being hosted separately from the application server 10, the applications reside on said application server 10. The dynamically generated content of the page can be information gathered on the fly, in conformance with the application being implemented, from different systems such as a database 19 and/or a content provider 20 and other backend applications and systems (not shown). The application server 10 is linked to the database 19 and the content provider 20 through the network 14 (as illustrated in FIG. 1). However, the server 10 could be linked to these and other systems through a private network (not shown) to which the client computing device 12 does not have direct access. For example, the application server 10 may comprise an application server of a financial institution such as a bank that, upon receiving a user request, dynamically gathers from the database 19 bank account data specific to the user and delivers this to the user's computing device 12 as a web page. Thus, the requested web page, some of whose content has been dynamically generated by the application server 10, provides content including user specific data.

The application server 10 may comprise an International Business Machines' (IBM) Websphere Application Server (Websphere is a tradename of IBM) or an Apache Tomcat enabled server (Apache Tomcat comprises software code provided by the Apache Software Organisation).

In this embodiment, the pages may be configured as HTML files but could comprise files of any known suitable file format. For example, the page may comprise a JavaServer Page (JSP) or a Java Servlet. JSPs and Java Servlets are Java software components that execute within an application server to generate dynamic content for pages in response to requests received from a browser. The dynamically generated content may be configured as HTML files. New pages and/or new content for existing pages may be provided by the content provider 20. The content provider 20 may comprise a separate server device or may form part of the application server 10.

The client computing device 12 may, for example, comprise a personal computer (PC) but could equally well be any other device capable of connecting to the network 14 including a laptop computer, an Internet Protocol (IP) telephone handset, a handheld computer, a mobile communications device or the like. A skilled artisan will be cognisant of the many different forms the client computing device 12 can take. In each case, the client computing device 12 includes a browser 22 running browser software that allows a user to select a page for retrieval from the application server 10, to interpret the content of the page and to display its content on a monitor 24 of the client computing device 12. To achieve this, the user enters into the client computing device, by typing, for example, the unique network address for the requested page. The browser software 22 and server software 16 communicate through the network using one or more predefined protocols. Where the network 14 comprises the Internet, the predefined protocol may be the Hypertext Transfer Protocol (HTTP) although other protocols such as the File Transfer Protocol (FTP) or the Network News Transfer Protocol (NNTP) may be used instead of or in concert with HTTP. In the case of a private network, the network communication protocol could be a proprietary protocol. Many other protocols are used on the Internet but these are often employed for different purposes other than that of the present invention such as the Voice over Internet Protocol (VoIP), for example, which allows users to place a telephone call over the Internet. However, the pages stored in the application server may include links to other pages and objects located in the network and some of these objects may make use of such other protocols.

In the case of the Internet, the unique network address for a page takes the form of a Universal Resource Locator (URL). A URL specifies the Internet address of a page stored on a server connected to the Internet. Every page on the Internet, no matter what its access protocol, has a unique URL. The browser 22 uses the URL to retrieve a copy of the requested page from the server 10.

As illustrated in FIG. 1 by way of example, the page retrieved from the application server 10 may comprise a web page some of whose content is dynamically generated and which is specific to the user requesting it. A web page may be written in a text-formatting language called Hypertext Markup Language (HTML) that describes the structure and character formatting of the document file content. A page is simply a data-set of text and instructions that is understood by the client computing device browser software. A page can contain links in the form of Hypertext to other pages and media objects located in the Internet. Such links form part of the displayed contents of a web page. A user can access other web pages, for example, through these links. These web pages may form part of a set of web pages belonging to a single application or entity, e.g. the web pages for a financial institution such as a bank, or they could comprise links to the web pages of other applications or entities that the web page designer considers as being of interest to a browser of the content of his web page. It will be noted that each web page, whether it forms part of a set or not, has its own unique network address. In most cases, the links do not follow a logical order which makes navigation through the links difficult. The web browser therefore includes a cache 26 which stores downloaded web pages temporarily in a memory of the client computing device 12. Thus, if a user revisits a web page address, the browser 22 can retrieve the page from the cache 26 rather than perform a new file retrieval operation over the network. This is one method by which browsers reduce unnecessary network traffic flows.

Also for the purpose of making navigation through web pages more easy, the browser 22 provides a book marking feature by which it enables a user to store as bookmarks 28 the unique networks addresses (URLs) of web pages that he may wish to revisit. This enables a user to point to the address of interest in his bookmark list 28 rather than having to re-enter it by typing, for example, in the browser each time he wishes to revisit the web page. In many cases, the web page displayed to the user will be retrieved from the client computing device's cache 26 rather than reloaded from the server 10.

Known web browsers such as Microsoft Internet Explorer and Netscape Navigator offer a “reload” or “refresh” feature whereby, because a web page may be frequently updated such that the cached content may no longer be current, the web page is reloaded from the server into the client computing device to provide access to current content.

In this first preferred embodiment of the present invention, there is provided a message broker agent 30 which receives in real-time notifications from the applications 20 of changes in or new content for a page stored in the application server's memory 18. These notifications are relayed, also in real-time, by the message broker agent to the browsers 22 of affected client computing devices 12. The message broker agent 30 comprises a separate server device 31 in the network 14, but it could be implemented as a software module of the server software 16 of the application server 10.

The client computing device browser 22 includes a push client agent 32 which, upon receipt of a notification, automatically reloads from the application server 10 the page whose content has been changed etc. as identified in the notification. The page that has been changed may be identified by including its URL in the change notification. Thus, the page file cached in the client computing device 12 is updated by automatically reloading it from the application server 10 in response to an application 17 issuing a change notification. The push client agent 32 may form part of the browser software running on the client computing device 12. The change notification may be issued by the message broker agent 30 as a general notification to all client computing devices 12 that have “registered” with the message broker agent 30. In a preferred arrangement, the change notifications are more specifically directed to client computing devices 12 as will be apparent from the following.

The push client agent 32 may use as its list of page addresses to be updated automatically in response to receipt of a change notification the bookmarked URLs stored in the browser bookmark list 28. These are communicated to the message broker agent 30 so that the agent 30 can determine which, if any, received page content change notifications should be communicated to a user's client computing device 12. Preferably, however, the push client agent 32 enables the user to store in the browser 22 as a separate list 34 those URLs that the user wishes to be reloaded when such pages are changed. The URL list 34 may comprise a user selected subset of the URLs from the bookmark list 28 or may comprise a list prepared by the user entirely separately from the bookmark list 28. The advantage of enabling the user to construct a separate list 34 of URLs, whether as a subset of the bookmarked list 28 or otherwise, is that users often bookmark, in an almost random manner, any web page that is remotely interesting to them and, as such, the bookmark list 28 quickly increases in size and becomes difficult to manage. In addition, although the content of some of the bookmarked sites in the list 28 may be regularly updated, the user may not have any interest in keeping the cached content of these particular sites updated.

In addition to communicating the URL list 34 to the message broker agent 30 at the time the list is first constructed, the push client agent 32 may resend the list to the message agent 32 each time the user adds to or amends the list or it may communicate only additions and amendments to the list. Alternatively, the push client agent 32 may delay communicating the URL list 34 or any additions and/or amendments to it until the next time it receives a change notification.

An application 17 may communicate a change notification to the message broker agent 30 only when the content of a web page has been substantively changed and/or changed by a substantial amount. The process for determining when to issue such a notification may be made in accordance with known methodologies.

The push client agent 32 is arranged such that a page is reloaded in the background in response to receipt of a change notification, i.e. it need not let the browser 22 display the reloaded content on the client computing device monitor 24 unless the user is already viewing the cached content of that page.

The push client agent software code may form a plug-in part of a browser software product that can be supplied on a machine readable medium and loaded and run as an enhanced browser on a client computing device 12. Alternatively, the push client agent code may be a once only download to the browser 22 of the client computing device 12 from the message broker agent 30 or any other suitable code source.

In a specific implementation of the first embodiment of the invention, the message broker agent 30 comprises a publish/subscribe engine. A publish/subscribe engine is a broker device that serves a plurality of client devices that can range from servers to hand held computing devices. Each client device is either a publisher or a subscriber. A publisher sends information to the broker on a certain topic. A subscriber registers their interest in a specific topic with the broker. The broker relays information on the specified topic received from the publisher to the subscriber. The broker can apply logic to the received messages in order to route messages based on their topics or contents. An example of a publish/subscribe broker is the International Business Machines' (IBM) Websphere MQ Event Broker.

In the context of this implementation of the present invention, the publisher clients comprise the applications 17 and the subscriber client comprises the client computing device push client agent 32. The client computing device push client agent 32 identifies URLs as its topics of interest. Where the message broker 30 uses the IBM Websphere MQ Telemetry Transport protocol (WMQTT) for receiving and relaying messages (notifications), the applications 17 and client computing device push client agent 32 are each connected to the message broker 30 through a Transport Control Protocol/Internet Protocol (TCP/IP) socket listener on a configurable port. The default port is 1883, which has been allocated by the Internet Assigned Numbers Authority (IANA) for the WMQTT. The push client agent 32 acts as a subscriber client receiving change notification messages which automatically trigger the execution of code in the browser plug-in push client agent 32. In executing the code, the plug-in tells the browser 22 to load the URL specified in the message or asks it to reload the current page.

The push client agent 32 can be implemented in different forms. As has already been described in the foregoing, the push client agent 32 may comprise plug-in code forming part of an enhanced browser. As an alternative, the push client agent 32 may comprise a Java applet or the like hidden in a downloaded page. In this alternative implementation of the push client agent 32, a Java client version of WMQTT is employed.

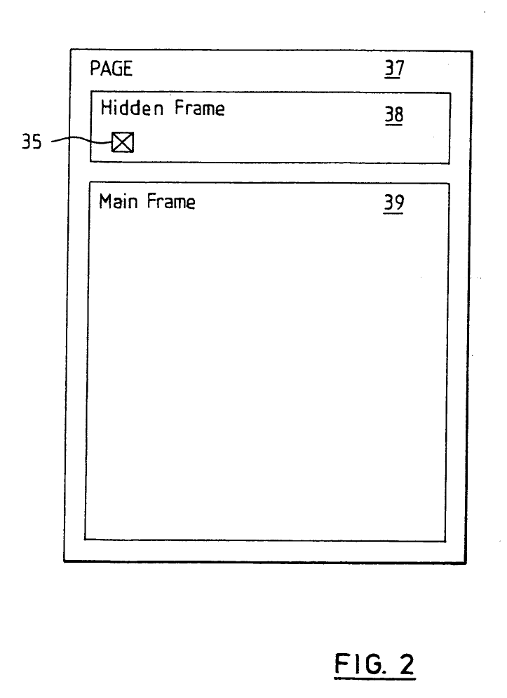

As illustrated in FIG. 2, the downloaded page 37 comprises a first frame 38 hidden from a user in which a Java applet 35 is embedded and a second or main frame 39 which takes up the whole of the browser display area and which, under control of the Java applet in a known manner, controls which pages are displayed in the main frame 39.

The hidden Java applet acts as a subscriber client receiving in real-time change notification messages from the applications 17 via the message broker agent 30. When the Java applet receives a change notification message, an automatic push client trigger mechanism causes the applet to execute a piece of Java code. This push client trigger mechanism is provided by the Java client version of WMQTT. Within the executed Java code, the applet processes the received change notification message. The message may contain the URL of a page to be updated by reloading it into the main frame 39 or a request to reload the current page being displayed in the browser 22.

The push client agent 32 comprising a Java applet as aforesaid may also use a socket type connection to the message broker agent 30 as hereinbefore described.

Other socket based browser technologies may be employed such as Microsoft's ActiveX or COM objects. The push client agent 32 could be implemented as an ActiveX or a COM object that could be downloaded and used in a like manner to a hidden Java applet.

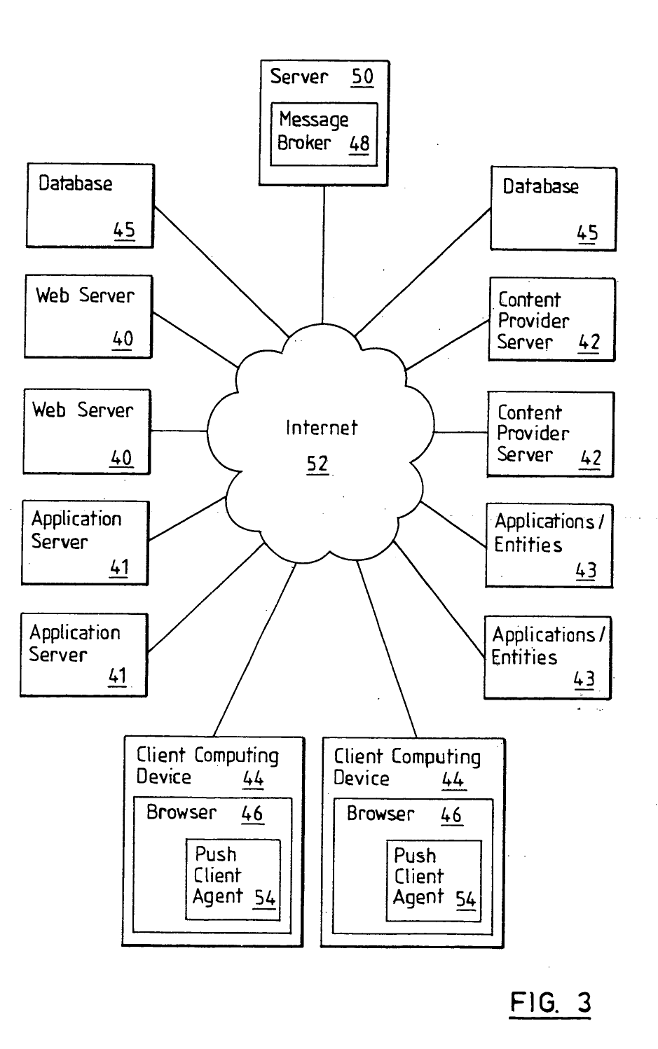

Referring to FIG. 3, there is shown a second preferred embodiment of the invention. This comprises a plurality of web servers 40, each hosting a multiplicity of web pages in a known manner, a plurality of application servers 41 for dynamically generating web page content in response to user requests, a plurality of content provider servers 42 for providing new and updated content for said web page files for application/entities 43 serviced by said content provider servers 42, a plurality of databases 45 for providing information to the applications/entities 43 and a plurality of client computing devices 44, each having a browser 46 for accessing web pages in a similar manner to that discussed with respect to the first embodiment. The applications/entities 43 may reside on the application servers 41 or may comprise separate application servers 43.

In this embodiment, a message broker 48 is hosted on a message broker server 50. All of the servers 40, 41, 42 & 50, the applications/entities 43, the databases 45 and the client computing devices 44 are interconnected by the Internet 52.

The applications/entities 43 comprise publisher clients of the message broker 48 and the client computing device push client agents 54 comprise subscriber clients of said message broker 48. Each client computing device registers through its respective push client agent 54 the URLs of web pages that it wishes to maintain in an updated form. The message broker receives in real time change notifications (messages) from the applications/entities 43 when the content of a web page is being changed and relays these in real time to those client computing devices 44 that have registered with the message broker 48 an interest in the URL of that web page. Receipt of the change notification causes the push client agent 54 to reload the web page whose content has been changed. As discussed with respect to the first embodiment, the message broker 48 may comprise a publish/subscribe engine of the type represented by IBM's Websphere MQ Event Broker.

As in the first embodiment, the push client code that comprises the push client agents 54 may comprise a Java applet or the like embedded in a downloaded web page which can run-on a Java compatible browser 46. The Java applet push client agent downloaded in this way causes the browser to communicate the URL of the downloaded web page to the message broker 48 to register the client computer device's interest in receiving content change notifications for that URL. A disadvantage of this arrangement is that the Java applet push client agent so formed only enables content updating of the web page that the Java applet was embedded in.

In an alternative arrangement, the Java applet is automatically inserted by the browser 46 into subsequently downloaded web pages from the same site and performs the same steps to cause updating of content of these web pages as described above. In this way, the Java applet push client agent can be utilised to update, through reloading, all of the content of all pages of a web site.

The present invention provides a real-time means of automatically updating the content of a user pre-selected set of web pages without any activity required on the part of the user to initiate each web page updating procedure. This offers many advantages including reducing unnecessary web page reload operations and thus reducing network traffic.

1. A method of automatically reloading a page on a client computing device, characterised in that it comprises the steps of
storing a page on a server;
transmitting a copy of the page to a browser of the client computing device in response to a request from said browser received at said server, said copy of the page being transmitted to the browser over a network connecting the client computing device to the server;
updating the content of the page stored on the server;
simultaneously transmitting a message to said browser notifying it of a change in the content of the page; and
on receipt of said change content message, causing said browser to automatically request a copy of the updated page.

2. A method as claimed in claim 1, characterised in that the change message is generated by an application implementable by the server.

3. A method as claimed in claim 1, characterised in that the server is an application server.

4. A method as claimed in claim 3, characterised in that the change message is relayed to the browser of the client computing device by a message broker server.

5. A method as claimed in claim 4, characterised in that the message broker server comprises a publish/subscribe engine and in that the change message. is communicated to the browser using a socket transport protocol.

6. A method as claimed in claim 2, characterised in that it includes the steps of the client computing device browser registering with the message broker agent/server the network address of a page and the message broker agent/server determining on the basis of said registered network page address whether a received change message is to be communicated to the browser.

7. A method as claimed in claim 6, characterised in that the browser registers with the message broker agent/server a plurality of network addresses for pages which are used by the message broker agent/server to determine if a received change message is to be communicated to the browser.

8. A method as claimed in claim 7, characterised in that the network addresses registered by the browser with the message broker agent/server comprise a bookmark list of the browser.

9. A method as claimed in claim 7, characterised in that the network addresses registered by the browser with the message broker agent/server comprise a user selected list of network addresses.

10. A method as claimed in claim 8, characterised in that the network addresses registered by the browser with the message broker agent/server comprise a user selected subset of the browser bookmark list.

11. A method as claimed in claim 1, characterised in that the program code for causing said browser to automatically request a copy of the updated page upon receipt of a change message forms part of the browser software.

12. A method as claimed in claim 11, characterised in that the program code for causing said browser to automatically request a copy of the updated page upon receipt of a change message is downloaded from the message broker agent/server.

13. A method as claimed in claim 1, characterised in that the program code for causing said browser to automatically request a copy of the updated page upon receipt of a change message comprises a Java applet embedded in a downloaded page.

14. A method as claimed in claim 13, characterised in that the browser embeds the Java applet into subsequently downloaded pages from the same website.

15. A system for automatically reloading a page on a client computing device, characterised in that it comprises:
a server for storing a page;
a client computing device having a browser;
a network connecting the server to the client computing device, the arrangement being such that a copy of the page stored on the server is transmitted over the network to the browser of the client computing device in response to a request received at the server from the browser;
a message broker agent for receiving a message that the content of the page has been changed and for transmitting in real-time a message to the browser to notify it that said content has been changed;
wherein said browser is arranged, upon receipt of the change message, to request an updated copy of the page from the server.

16. A system as claimed in claim 15, characterised in that the server comprises an application server for implementing applications.

17. A system as claimed in claim 15, characterised in that the message broker agent comprises a publish/subscribe engine and in that the message broker agent and a push client agent of the browser are connected by a Transport Control Protocol/Internet Protocol (TCP/IP) socket connection.

18. A system as claimed in claim 15, characterised in that a push client agent of the browser comprises a plug-in part of the browser software.

19. A system as claimed in claim 15, characterised in that a push client agent of the browser comprises a Java applet or the like embedded in a page downloaded by the browser.

20. A client computing device for implementing the method of claim 1.

21. A message broker server for implementing the method of claim 1.

22. Software code for implementing the method of claim 1.

23. A computer program on a machine readable medium for implementing a browser for a client computing device as claimed in claim 20.
